(19) United States
(12) Patent Application Publication
(10) Pub. No.: US 2020/0176154 A1
(43) Pub. Date: Jun. 4, 2020

(54) METHODS AND COMPOSITIONS FOR SUPERPARAMAGNETIC PARTICLES FOR NUCLEIC ACID EXTRACTION

(71) Applicant: Theranos IP Company, LLC, Healdsburg, CA (US)

(72) Inventor: Alex Ho Fai Lee, Fremont, CA (US)

(21) Appl. No.: 16/700,585

(22) Filed: Dec. 2, 2019

Related U.S. Application Data
(63) Continuation of application No. PCT/US0018/035704, filed on Jun. 1, 2018.
(60) Provisional application No. 62/642,774, filed on Mar. 14, 2018.
(60) Provisional application No. 62/513,999, filed on Jun. 1, 2017.

(51) Int. Cl. H01F 1/00; H01F 1/20

(52) U.S. Cl. CPC H01F 1/0054; B82Y 25/00; H01F 1/20

(57) ABSTRACT

A composition is described comprising superparamagnetic particles. Optionally, the particles comprise microbeads. Optionally, the particles comprise nanobeads. Optionally, the particles are non-spherical particles. Optionally, the particles are non-spherical particles suitable for RNA or DNA extraction. A method is described for forming microparticles. Optionally, the method comprises using citrate precipitation. Optionally, a kit comprising one or more of the particles is described. Optionally, a kit for sample preparation for nucleic acid extraction is described comprising non-spherical microparticles or nanoparticles.

### BACKGROUND

Magnetic particles have received a great deal of attention in biological, medical, diagnostic and engineering areas. Unfortunately, manufacturing cost and complexity associated with use of such particles have been barriers to broader implementation.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### COPYRIGHT

This document contains material subject to copyright protection. The copyright owner (Applicant herein) has no objection to facsimile reproduction of the patent documents and disclosures, as they appear in the US Patent and Trademark Office patent file or records, but otherwise reserves all copyright rights whatsoever. The following notice shall apply: Copyright 2017-2018 Theranos, Inc.

### SUMMARY

The disadvantages associated with the prior art are overcome by embodiments described herein.

Magnetic nanoparticles or microparticles as disclosed herein are suitable for biological, medical, diagnostic and engineering areas, because of their magnetic properties, versatility in immunity separations, applications as MRI contrast agent, biosensor and the targeted drug delivery. Of particular interest are superparamagnetic particles constructed from materials such as but not limited to Iron (II, III) oxide (Fe₃O₄—magnetite).

One non-limiting example herein describes one embodiment of the preparation of iron oxide silica particles. In one non-limiting example, the particles may be suitable for various uses such as RNA extraction.

Superparamagnetic particles constructed from Iron (II, III) oxide (Fe₃O₄—magnetite) has potential in binding, extraction and purification of biomolecules including RNA, DNA, proteins, enzymes and organic small molecules; they may be used as MRI contrast agents; and as carriers of biomarkers and drugs. The versatility of superparamagnetic particles derives from the combination of an iron oxide core (typically Fe₃O₄) with a variety of coating materials. When the particles are placed in a magnetic field, they develop a strong internal magnetization from exchange coupling of electrons. This allows their movement to be controlled by the external magnetic field. When the field is removed, particles are no longer magnetized and have no magnetic memory. However, Fe₃O₄ is readily oxidized to hematite (Fe₂O₃), changing its magnetism from superparamagnetic to ferromagnetic. To avoid oxidation and to protect the metal core, natural and synthetic polymers and silica have been employed to coat the magnetic particles. A wide range of chemical functional groups can be introduced on the coating surface to increase stability, wetting properties and binding flexibility for various applications. Chemical functionalization by amines, carboxylic acids, epoxy, and aldehydes is usually used to immobilize proteins, enzymes, RNA, DNA biomolecules on the surface via covalent linkages.

Other approaches have been developed because the use of ethanol and other solvents was not compatible with automated molecular diagnostic platforms.

In one embodiment described herein, a composition is provided comprising superparamagnetic particles. Optionally, the particles comprise microbeads. Optionally, the particles comprise nanobeads. Optionally, the particles are non-spherical particles. Optionally, the particles are non-spherical particles suitable for RNA or DNA extraction.

In another embodiment described herein, a method is provided for forming microparticles. Optionally, the method comprises using citrate precipitation.

In another embodiment described herein, a kit comprising one or more of the particles is provided. Optionally, a kit for sample preparation for nucleic acid extraction is provided comprising non-spherical microparticles or nanoparticles. Optionally, the particles comprise sphere-like magnetic aggregate with a size range of about 1 to about 2 microns. Optionally, the particles comprise sphere-like magnetic aggregate with a size range of about 0.5 to about 3 microns.

In at least one embodiment described herein, a robust synthetic pathway for magnetic core preparation and silica surface coating of magnetic microparticles is presented. Silica-coated magnetic particles are widely used to extract DNA and RNA from various biological samples. In one non-limiting example, a novel route for the synthesis of iron oxide silica particles (Fe₃O₄@Silica core-shell) and demonstrate their performance for extracting ZIKA viral RNA from serum. The iron (II, III) oxide (Fe₃O₄), magnetite core is first prepared by ammonia neutralization of ferrous and ferric chloride aqueous solution under argon, followed by the addition of citrate salt to stabilize the surface of the resultant magnetic nanospheres. After this one-pot, two-step synthesis, the magnetic nanospheres are consumed during silica coating by hydrolysis of tetraethoxysilane (TEOS) under alkaline condition. In this non-limiting example, the final product is a sphere-like magnetic aggregate with a size range of 1-2 micron. By simply suspending the magnetic aggregates in guanidinium chloride solution, the silica surface can be prepared for RNA binding. The RNA extraction efficiency was evaluated by extracting ZIKA viral RNA from serum followed by a PCR-based assay. The data indicate excellent recovery of target RNA and removal of PCR inhibitors. This manufacturing procedure for the silica coated microparticles provides a low-cost, effective and ready for scale-up method whose performance is equivalent to commercial alternatives such as magnetic silica surface particles for DNA and RNA sample preparations. The cost of the clinical assays could be largely decreased due to the 100 fold reduction in cost by replacing the commercially available magnetic particles with the developed material for RNA extraction.

In one embodiment, a method is provided comprising at least one technical feature described herein. Optionally, a method is provided comprising at least any two technical features described herein. Optionally, a kit is provided comprising at least one technical feature described herein. Optionally, a kit is provided comprising at least any two technical features described herein. Optionally, a system is provided comprising at least one technical feature described herein. Optionally, a system is provided comprising at least any two technical features described herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIGS. 1A to 1D show the following, respectively: (1a) 800× optical microscope image of citrated Fe₃O₄. (1b) Same magnification of TEOS surface beads used in this assay. 1(c) Commercial Zymo product. (1d) Silica surface beads prepared by another method based on seed polymerization described in supporting information section. Aggregation is observed in samples (a) and (c).

FIG. 2 shows one non-limiting example of a scheme for formation of Silica surface on SPIONs with TEOS.

FIG. 3 shows dynamic light scattering (DLS) for sizing with Z-average diameter=1.68 um, PDI=0.355, Peak 1=1.89 um (91.6%), Peak 2=0.098 um (8.4%).

FIG. 4 shows one non-limiting example of preparation of spherical monodispersed microparticles (polymer based).

FIGS. 5A and 5B show 800× magnification of microscopic images: in-house silica coated polymer microparticles (FIG. 5A); reference 2.8-2.6 um Dynabeads® (FIG. 5B).

FIGS. 6A to 6D show 800× magnification of microscopic images: Zymo MagBinding® beads (FIG. 6A); in-house silica coated microparticles used in Zika assays (FIG. 6B); in-house citrate surface aggregated magnetic nanoparticle-precursor of silica coated microparticles (FIG. 6C); reference 1 um Dynabeads® (FIG. 6D).

FIG. 7 shows dynamic light scattering (DLS) size measurements of Fe₃O₄@Silica particles according to one non-limiting example described herein.

FIG. 8 shows the preparation of silica surface spherical monodispersed microparticles (polymer based), and the additions of variable MPTMS, TEOS, APTES according to embodiments herein.

FIGS. 9A-9B show (a) SEM analysis of Fe₃O₄@Silica with 500 nm & 10 μm scales. (b) SEM analysis of Fe₃O₄@Silica with 50 nm & 1 μm scales according to non-limiting examples as described herein.

FIG. 10 shows one non-limiting example of the preparation of Fe₃O₄@Silica particles in 1-pot 2-step pathway and workflow of Zika viral RNA extraction with magnetic separation.

### DESCRIPTION OF THE SPECIFIC EMBODIMENTS

It is to be understood that both the foregoing general description and the following detailed description are exemplary and explanatory only and are not restrictive of the invention, as claimed. It may be noted that, as used in the specification and the appended claims, the singular forms “a”, “an” and “the” include plural referents unless the context clearly dictates otherwise. Thus, for example, reference to “a material” may include mixtures of materials, reference to “a compound” may include multiple compounds, and the like. References cited herein are hereby incorporated by reference in their entirety, except to the extent that they conflict with teachings explicitly set forth in this specification.

In this specification and in the claims which follow, reference will be made to a number of terms which shall be defined to have the following meanings:

“Optional” or “optionally” means that the subsequently described circumstance may or may not occur, so that the description includes instances where the circumstance occurs and instances where it does not. For example, if a device optionally contains a feature for a sample collection unit, this means that the sample collection unit may or may not be present, and, thus, the description includes both structures wherein a device possesses the sample collection unit and structures wherein sample collection unit is not present.

As used herein, the terms “substantial” means more than a minimal or insignificant amount; and “substantially” means more than a minimally or insignificantly. Thus, for example, the phrase “substantially different”, as used herein, denotes a sufficiently high degree of difference between two numeric values such that one of skill in the art would consider the difference between the two values to be of statistical significance within the context of the characteristic measured by said values. Thus, the difference between two values that are substantially different from each other is typically greater than about 10%, and may be greater than about 20%, preferably greater than about 30%, preferably greater than about 40%, preferably greater than about 50% as a function of the reference value or comparator value.

As used herein, a “sample” may be but is not limited to a blood sample, or a portion of a blood sample, may be of any suitable size or volume, and is preferably of small size or volume. In some embodiments of the assays and methods disclosed herein, measurements may be made using a small volume blood sample, or no more than a small volume portion of a blood sample, where a small volume comprises no more than about 5 mL; or comprises no more than about 3 mL; or comprises no more than about 2 mL; or comprises no more than about 1 mL; or comprises no more than about 500 μL; or comprises no more than about 250 μL; or comprises no more than about 100 μL; or comprises no more than about 75 μL; or comprises no more than about 50 μL; or comprises no more than about 35 μL; or comprises no more than about 25 μL; or comprises no more than about 20 μL; or comprises no more than about 15 μL; or comprises no more than about 10 μL; or comprises no more than about 8 μL; or comprises no more than about 6 μL; or comprises no more than about 5 μL; or comprises no more than about 4 μL; or comprises no more than about 3 μL; or comprises no more than about 2 μL; or comprises no more than about 1 μL; or comprises no more than about 0.8 μL; or comprises no more than about 0.5 μL; or comprises no more than about 0.3 μL; or comprises no more than about 0.2 μL; or comprises no more than about 0.1 μL; or comprises no more than about 0.05 μL; or comprises no more than about 0.01 μL.

As used herein, the term “point of service location” may include locations where a subject may receive a service (e.g. testing, monitoring, treatment, diagnosis, guidance, sample collection, ID verification, medical services, non-medical services, etc.), and may include, without limitation, a subject's home, a subject's business, the location of a healthcare provider (e.g., doctor), hospitals, emergency rooms, operating rooms, clinics, health care professionals' offices, laboratories, retailers [e.g. pharmacies (e.g., retail pharmacy, clinical pharmacy, hospital pharmacy), drugstores, supermarkets, grocers, etc.], transportation vehicles (e.g. car, boat, truck, bus, airplane, motorcycle, ambulance, mobile unit, fire engine/truck, emergency vehicle, law enforcement vehicle, police car, or other vehicle configured to transport a subject from one point to another, etc.), traveling medical care units, mobile units, schools, day-care centers, security screening locations, combat locations, health assisted living residences, government offices, office buildings, tents, bodily fluid sample acquisition sites (e.g. blood collection centers), sites at or near an entrance to a location that a subject may wish to access, sites on or near a device that a subject may wish to access (e.g., the location of a computer if the subject wishes to access the computer), a location where a sample processing device receives a sample, or any other point of service location described elsewhere herein.

### Materials & Methods

In contrast of introducing functionality for covalent bonding, the embodiments herein demonstrate the non-covalent binding of RNA molecules on the silica coating of superparamagnetic micro-particles. Although this is shown for RNA molecules, it should be understood that this binding is also applicable to other types of binding, such as but not limited to, DNA, proteins, enzymes, organic small molecules or other materials. In one non-limiting example, the sample preparation process uses a sorbent material or magnetic silica particle able to quickly bind to RNA molecules present in the sample fluid, followed by the application of an external magnetic field to isolate the RNA-bound particles from the sample fluid. It should be understood that other techniques for RNA or DNA sample preparation are not excluded. After separation, the RNA molecules are desorbed from the magnetic particles or carriers for subsequent nucleic acid amplification reactions. In the present non-limiting example, the superparamagnetic particles were coated with silica since rapid adsorption and desorption of RNA or DNA molecules was required. Conventional methods for DNA and RNA separation typically employ ethanol or isopropanol precipitation. This extraction method limits the scale-down of sample size and workflow for high-throughput screening and diagnostic tests. Silica surface adsorption of DNA and RNA addresses these limitations. Although commercial magnetic silica particles are available from several sources, the novel technique(s) to produce such particles reported in the present work is superior due to its simplicity, more straightforward preparation method than others reported, robustness in preparation, ease of use and cost effectiveness when applied.

In one non-limiting example, this process does not require special technique and instrument for controlling the size of particle formation. And the range of particle size we obtained performs well in the binding application of the assays. We are capable of controlling the reaction ratio of tetraethoxysilane (TEOS) and other silylated components with superparamagnetic particle seeds to adjust the surface functionality.

In this new method of preparation, superparamagnetic iron oxide nanoparticles (SPIONs) Fe₃O₄ were prepared by an alkaline co-precipitation of ferrous and ferric chloride aqueous solutions under argon without surfactants.

2Fe⁺(aq)+Fe⁺(aq)+8OH⁻→Fe₃0₄(s)+4H₂0

In contrast of introducing functionality for covalent bonding, this report demonstrates the non-covalent binding of RNA molecules on the silica coating of Fe₃O₄ micro-particles. In this non-limiting example, advantages of non-covalent binding may include (1) quick, simple release of the RNA molecules and easy removal of the Fe₃O₄@Silica particles after sample preparation, (2) yet allows a strong ionic binding between the beads' surface with the RNA molecules' phosphate backbone during purification. The sample preparation process requires a sorbent material or magnetic silica particle able to quickly bind to RNA molecules present in the sample fluid, followed by the application of an external magnetic field to isolate the RNA-bound particles from the sample fluid. After separation, the RNA molecules are desorbed from the magnetic particles or carriers for subsequent nucleic acid amplification reactions. In the present work, the Fe₃O₄ nanoparticles were coated with silica since rapid adsorption and desorption of RNA or DNA molecules was shown. Conventional methods for DNA and RNA separation typically employ ethanol or isopropanol precipitation. This existing extraction method limits the scale-down of sample size and workflow for high-throughput screening and diagnostic tests. Silica surface adsorption of DNA and RNA addresses these limitations. Although commercial magnetic silica particles are available from several sources, the novel technique to produce such particles reported in the present work is superior due to its simplicity, more straightforward preparation method, robust in preparation, ease of use and cost effectiveness than others reported. This process does not require special techniques and instruments for controlling the size of particle formation. And the range of particle size we obtained performs well in the binding application of the assays. We are capable of controlling the reaction ratio of tetraethoxysilane (TEOS) and other silylated components with iron (II, III) oxide particle seeds to adjust the surface functionality.

In at least one non-limiting example of this new method of preparation, iron oxide (Fe₃O₄) nanoparticles were prepared by alkaline co-precipitation of ferrous and ferric chloride aqueous solutions under argon without surfactants (Equation 1).

2Fe⁺(aq)+Fe⁺(aq)+8OH⁻→Fe₃O₄(s)+4H₂O

In this non-limiting example, Fe₃O₄ particles formed were treated with 2M nitric acid, followed with 0.5M sodium citrate to prepare the surface for silica coating and SPION stabilization with citrate. Optionally, Fe₃O₄ particles formed were treated with 2-3M nitric acid, followed with 0.2-0.6M sodium citrate to prepare the surface for silica coating and SPION stabilization with citrate. This 1-pot, 2-step procedure leads to citrate surface-stabilized superparamagnetic particles that can be stored in dry form at 4° C. Re-suspension and sonication of these dry particles in 8% to 12% v/v water in ethanol, followed by silica shell formation with hydrolysis of tetraethoxysilane (TEOS) under alkaline condition using 28-30% ammonia, results in silica magnetic particles that can be separated without further purification (See Scheme 1 shown in FIG. 2). The mass ratio of the silica coating to SPION was found to be around 55% averaged over multiple batches using a reactants ratio of TEOS:NP, 4:1 w/w. Different silica mass ratio were obtained by using different reactants ratio of TEOS:NP. In one non-limiting example, we observed a higher silica mass ratio than 55% was not preferred as the additional weight of the silica shell resulted in a slower magnetic response of the coated SPION. To ensure complete enclosure of SPIONs by the silica shell, lower reactant ratio such as TEOS:NP=1:1 w/w was not persuaded. Alternate methods to prepare such beads were also tested and are not excluded from embodiment herein; for example, polymerizing a mixture of (1) TEOS with γ-aminopropyl-triethoxysilane (APTES); (2) TEOS with (3-mercaptopropyl)trimethoxysilane (MPTMS); and (3) amino surface of magnetic polystyrene particles reacted with (3-glycidyloxypropyl)trimethoxy silane (GLYMO) (see supporting information). Although they may all have longer synthetic pathway compared to silica surface beads prepared in Scheme 1, they are not excluded from embodiments herein. In addition, results generated from a comparison of beads in a nucleic acid assay indicated that magnetic particles with silica surfaces formed with TEOS provided comparable performance to commercially available Zymo product used for RNA separation from biological samples (see below).

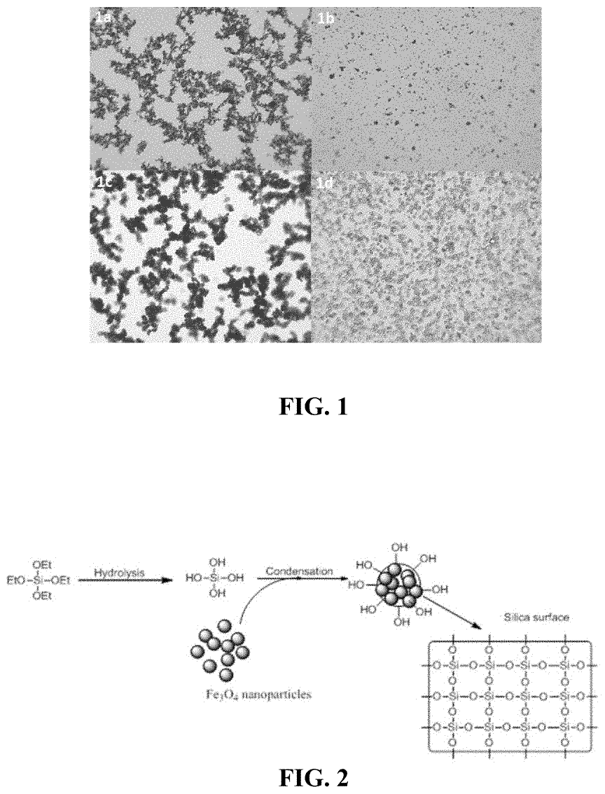

In one non-limiting example, aggregated nanoparticles with citrate surfaces, see FIG. (1a), were observed under 800× optical microscope. After completing the coating step, the micro-particles (1b) were less aggregated. Dynamic Light Scattering (DLS) analysis indicated that the silica-coated superparamagnetic particles were 1.68 μm in diameter on average (Peak 1=1.89 μm, 91.6%; Peak 2=98.35 nm, 8.4%). To prepare these micro-particles for RNA or DNA binding, (1b) was formulated in 1M guanidinium chloride solution as a 10% w/v suspension mixture. FIG. 1c) shows an image of commercial Zymo magnetic particles at the same magnification. This preparation method was further optimized to avoid aggregation if it is deemed to decrease the performance. FIG. 1d) shows the well-defined silica-coated magnetic particles of 2 μm diameter, generated by alternative seed coating method described in supporting information section. This preparation in Scheme 1 does not require polymerization of core and multiple coatings for surface functionality like other reported methods. The simplicity and robustness of the method described here makes it very valuable for large-scale, low cost use in DNA and RNA separations, while providing comparable performance to commercially-available products Zymo MagBinding® product that are significantly more costly. The micro-particles prepared by the current method are smaller in size and exhibit less aggregation relative to the commercial products. These two properties provide useful features: (1) smaller size provides same weight of particles containing higher surface area for RNA or DNA loading during sample preparation step; (2) less aggregation, on the other hand results in availability of higher loading areas for binding; (3) a well-defined spherical shape may not be an essential property for the particles made here when they are used as the sorbent material. Thus, the use of particles with imprefect spherical shapes are shown. Optionally, the use of particles with rounded but not well-defined spherical shapes are shown. Optionally, the use of particles with spheroidal but not well-defined spherical shapes are shown. Optionally, the use of particles with ovoid but not well-defined spherical shapes are shown.

Experimental results carried out in this work indicate functional performance is not compromised by the shape of the silica particles described here when compared to commercial magnetic micro-particles employed in the same applications. Zeta potential measurements show that the silica-coated particles have a −39.6 mV charge. The silica surface is negatively charged because of the deprotonation of silanol groups (SiO⁻). Once the micro-particles were formulated with 1M guanidinium chloride, Zeta potential of the silica superparamagnetic particles increased to −4.84 mV when measured in DI water.

To demonstrate the functional performance of these silica surface magnetic particles in RNA extraction, Zika viral RNA extraction from plasma, followed by PCR-based studies, were conducted. In this non-limiting example, two sets of experiments were performed to establish the utility of the functionalized magnetic micro-particles in the automated detection of Zika virus RNA. The rapid detection of Zika virus has received increased international attention due to the 2015 outbreak in South America and its association with congenital microcephaly. The critical initial step in Zika virus RNA detection assays requires RNA extraction by either manual or automated methods. The first set of experiments demonstrating the use of the magnetic micro-particles described in the current work for RNA extraction employed synthetic Zika RNA spiked into whole blood. These RNA samples were extracted and detected using Theranos miniLab equipment, a qualitative Zika virus nucleic acid amplification test. The second experiments used live Zika virus spiked into whole blood and detected using the same system. In addition, MS2 bacteriophage were spiked into the starting blood samples to serve as positive controls for sample preparation/RNA extraction and thermal cycling-based amplification and isothermal detection. The Theranos miniLab and Zika virus nucleic acid amplification test will be described in detail elsewhere (manuscripts in preparation).

Briefly, the Zika virus nucleic acid amplification tests were performed using single-use cartridges containing all necessary assay reagents and consumables that were processed on Theranos' automated, diagnostic platform (“miniLab”) capable of sample preparation and processing. The miniLab contains an automated, multi-channel liquid handling system, centrifuge, thermal-cycler, isothermal heat block with fluorescence detection capabilities, and network functionality. In the miniLab, blood samples were first centrifuged, the resulting plasma was subjected to lysis, and RNA was captured on magnetic beads (commercial or in-house synthesized). Beads were collected and transferred by a sleeved magnetic rod. Samples were washed in commercial wash buffers, and RNA was subsequently eluted from the beads into DNase/RNase-free water.

Detection of Zika RNA was accomplished in the miniLab by a two-step amplification/detection process. A preliminary reverse-transcription and thermocycler-based amplification of the RNA target took place. This was followed by a proprietary fluorescence-based nested isothermal amplification and Zika nucleic acid (or MS2) detection step. By nested, this embodiment uses a second set of primers, interior to the first set, that adds specificity to the overall detection (similar to “nested per”)—it further amplifies the product of the first reaction. Relative fluorescence measurements measured in “Relative Fluorescence Units” (RFUs) were taken every minute, with inflection times (or threshold cycle, Cₜ) used to report the detection of Zika RNA and MS2 control RNA. Non-templated controls (NTCs) (controls without Zika or MS2 samples) were run and measured within the same assay cartridges; all NTC reactions were negative.

In the synthetic Zika (sZika) RNA experiments, 600 copies/mL of synthetic target were spiked into capillary whole blood samples which were then processed using either commercial microparticles (MagBinding® beads, Zymo Research, Irvine, Calif.) (n=3), or the synthesized silica-coated superparamagnetic particles described in this paper (n=6).

TABLE 1

| | MS2 | sZika | NTC |
|---|---|---|---|
| Zymo Commercial beads | 15.9 (0.5) | 15.2 (1.4) | NA |
| Beads prepared in this work | 15.2 (0.7) | 17.7 (2.6) | NA |

Table 1 summarizes the inflection times determined using the Commercial and prepared beads in this work.

The second set of experiments used live Zika virus spiked into whole blood samples. The virus was added at 250 copies/mL. The results of comparing the Zymo commercial beads (n=2) and the beads prepared in this work (n=10) are shown in Table 2.

TABLE 2

| | MS2 | Zika | NTC |
|---|---|---|---|
| Zymo Commercial beads | 16.6 (1.0) | 13.2 (0.0) | NA |
| Beads prepared in this work | 15.6 (0.78) | 13.5 (1.0) | NA |

Inflection times in min (standard deviation)

These two sets of experiments demonstrated comparable performance between the commercial micro-particles and the synthesized micro-particles prepared in this work in capture and extraction of Zika RNA followed by detection of Zika RNA using the Theranos miniLab and Zika virus RNA detection test.

In conclusion, the silica surface superparamagnetic particles described in the current work performed as an outstanding alternative RNA/DNA adsorption medium for sample preparations in nucleic acid amplification techniques such as but not limited to thermocycling assays or PCR-based assays. These magnetic particles prepared in this work weighed about 55% of the total mass, and dispersed well in aqueous and 1M guanidinium chloride solution in 10% w/v ratio for applications. It was shown that mono-dispersity is not a critical material requirement for yielding performance in RNA extraction. Preparation of magnetic particles presented here features simple with short synthetic pathway. Finally, this method allows economical production at larger scale without compromising performance characteristics. Through this work it is concluded that this simple and cost effective method does not compromise the quality of RNA extraction.

### Materials

All chemicals of analytical reagent grade were commercially available and used without further purification. Ferric chloride hexahydrate (FeCl3.6H2O), ferrous chloride tetrahydrate (FeCl2.4H2O), styrene, glycidyl methacrylate (GMA), divinylbenzene (DVB), azobisisobutyronitrile (AIBN), polyacrylic acid, guanidine hydrochloride (>99%) and ethanol anhydrous were obtained from Sigma Aldrich. Ammonia in water 28-30% w/w, sodium citrate tribasic dihydrate, nitric acid (90%) were obtained from BDH. Tetraethyl Orthosilicate (TEOS), 3-glycidyloxypropyltrimethoxysilane (GTMOS), (3-Aminopropyl)triethoxysilane (APTES) were purchased from TCI (USA). All aqueous solutions were prepared with deionized water obtained from a Milli-Q Integral system (resistivity=18 MΩ cm, EMD Millipore). Zymo MagBinding® Beads was obtained from Zymo Research, USA for comparison in RNA binding. Dynabeads® MyOne™, M280 from Thermofisher were used as the microscopic reference sizing materials, employed at 800× magnification.

### Instruments

The size, polydispersity index (PDI) and zeta potential of microparticles were measured by ZETASIZER NANO ZSP (Malvern). Microscopic Images were obtained from optical microscope with 800× magnification. NAA

### Dynamic Light Scattering and Zeta Potential Measurements

Dynamic light scattering (DLS) and zeta potential measurements were obtained using a Malvern ZETASIZER NANO ZSP. The sample concentrations were adjusted to ˜0.1% w/v particles in deionized water. The samples were sonicated in ultrasonic bath for 1 min and pre-equilibrated for 3 min at 25° C. prior to each measurement.

Preparation of Fe₃O₄ Nanoparticles Seeds

In this non-limiting example, Fe₃O₄ nanoparticles were prepared by the basic co-precipitation method. 4.46 g (16.6 mmol) FeCl3.6H₂0 and 1.8 g (8.3 mmol) of FeCl2.4H₂0 were dissolved in 80 ml of deionized water at room temperature. The solution was degassed by bubbling with Ar for 5 min and magnetic stirring in conical flask. 10 ml of ammonia 28-30% w/w was added dropwise to the solution and stirred for another 10 min. at room temperature. Following with heating for 1 h at 90° C., iron oxide magnetite (Fe₃O₄) formed was cooled down to room temperature and magnetically separated, washed with deionized water until pH8 reached. Optionally, heating for 0.5 to 1.5 h at 80-100° C. may be used,

The separated particles above reacted with 30 ml aqueous solution 2M HN03 for 5-10 min. After the reaction, the particles were washed with deionized water and magnetically separated until the pH reached ˜2.5. Then, 10 ml aqueous solution of 0.5M sodium citrate was added to the 30 ml particles suspension. The resulting solution was stirred for 1 h at room temperature. Finally, the citrate surface stabilized particles were magnetically recovered, washed thoroughly with deionized water and freeze-dried. Dried beads weighed 1.77 g (MW 231.53, 7.6 mmol); yield=88%. Zeta potential measured was −28.5 mV.

Coating Silica on Aggregated Fe₃O₄ Nanoparticles Seeds for Zika Assays

Silica coating of the particles was performed by hydrolysis of tetraethyl orthosilicate (TEOS) in alkaline conditions using ammonia 28-30% w/w as a base. A suspension of the aggregated nanoparticles NP (1500 mg, from above preparation) in 60 mL ethanol and 3 ml deionized water was sonicated for 10 min. Followed by the addition of 6 mL of TEOS and 3 mL ammonia 28-30% w/w. The reaction was performed under sonication and periodically vortex mixing for 15 min at room temperature. Then the reaction temperature was raised to 90 C on the magnetic stirring plate for 1 h. After that, 15 ml deionized water was added and stirring for another 5 h at 90 C. The particles formed were magnetically recovered as a black powder and washed thoroughly with deionized water. At the end, the silica coated magnetic microparticles were rinsed with ethanol and dried in vacuum. Dried microparticles weighed 3.4 g. The mass ratio of silica coating was found by the following equation:

Mass ratio_{(silica coating)}=(Mass_{(silica coated particle)}−Mass_{(starting particles))}/Mass_{(silica coated particles)}

The preparation above was an example of TEOS:NP=4:1, and the mass ratio was found to be 55%. Different ratios of tetraethyl orthosilicate (TEOS) versus weights of aggregated nanoparticles NP or starting particles were examined, ranging from 2:1, 4:1 to 6:1. Corresponding mass ratios ranged from 4562%, 55% and 62%. A mass ratio of TEOS vs starting particles NP of 1:1 was not examined because of the possibility of incomplete silica coating on the magnetic particles. Zeta potential of this magnetic microparticles measured was −39.6 mV. Dynamic light scattering (DLS) for sizing was recorded as below:

### Preparation of 10% w/v of the Silica Magnetic Microparticle in 1M Gu·Cl Buffer for Zika Assays

In one non-limiting example, 100 mg of the silica magnetic microparticles prepared above were suspended in 500 uμl deionized water, then added with 2M Gu·Cl buffer to make up to 1.0 ml final volume. Zeta potential of this formulated silica coated magnetic microparticles was measured as −4.84 mV.

### Preparation of Spherical Monodispersed Microparticles (Polymer Based)

In one non-limiting example, synthesized amine surface polymer microparticles served as seeds. 0.5 g were reacted with 0.2 ml 3-glycidyloxypropyltrimethoxysilane (GTMOS) for 1 h at room temperature in 5 ml ethanol, followed with 0.1 ml tetraethyl orthosilicate (TEOS) or a mixture of 0.1 ml tetraethyl orthosilicate (TEOS) and 0.2 ml (3-Aminopropyl)triethoxysilane (APTES) in 0.2 ml ammonia 28-30% w/w for 4 h at 90 C. After reaction, the magnetic particles were magnetically separated and washed with ethanol (5 times) with centrifugation at 3000×g or separated magnetically. Zeta potential measured microparticles with silica surface formed from (TEOS:APTES, 2;1, v/v)=+39.2 mV. microparticles with silica surface formed from TEOS only=+15.3 mV.

### Further Discussion

In one non-limiting example, to synthesize the Fe₃O₄@Silica for RNA extraction, the following chemicals of analytical reagent grade were received and used without further purification. Ferric chloride hexahydrate (FeCl3.6H₂O), ferrous chloride tetrahydrate (FeCl2.4H₂O), styrene, glycidyl methacrylate (GMA), divinylbenzene (DVB), azobisisobutyronitrile (AIBN), polyacrylic acid, guanidine hydrochloride (>99%) and ethanol anhydrous were obtained from Sigma Aldrich. Ammonia in water 28-30% w/w, sodium citrate tribasic dihydrate, nitric acid (90%) were obtained from BDH. Tetraethyl Orthosilicate (TEOS), 3-glycidyloxypropyltrimethoxysilane (GTMOS), (3-Aminopropyl)triethoxysilane (APTES) were purchased from TCI (USA). All aqueous solutions were prepared with deionized water obtained from a Milli-Q Integral system (resistivity=18 MΩ cm, EMD Millipore). Zymo MagBinding® Beads was obtained from Zymo Research, USA for comparison in RNA binding. Dynabeads® MyOne™, M280 from Thermofisher were used as the microscopic reference sizing materials, employed at 800× magnification.

Synthesis of Fe₃O₄@Silica from Iron Oxide Nanoparticles (Fe₃O₄) as Seeds

In one non-limiting example, Fe₃O₄ nanoparticles were prepared by the basic co-precipitation method. 4.46 g (16.6 mmol) FeCl3.6H₂O and 1.6 g (8.1 mmol) of FeCl2.4H₂O were dissolved in 80 ml of deionized water at room temperature. The solution was degassed by bubbling with Ar for 5 min and magnetic stirring in conical flask. 10 ml of ammonia 28-30% w/w was added dropwise to the solution and stirred for another 10 min. at room temperature. Following with heating for 1 h at 90° C., iron oxide magnetite (Fe₃O₄) formed was cooled down to room temperature and magnetically separated, washed with deionized water until pH 8 reached.

Fe₃O₄ particles formed in above method were treated with 2 M nitric acid for 5 min with stirrer mixing at room temperature, we believe this treatment can stabilize the Fe₃O₄ particle surface. After the reaction, the particles were washed with deionized water and magnetically separated until the pH reached ˜2.5. Then, 10 ml aqueous solution of 0.5 M sodium citrate was added to the 30 ml particles suspension. The resulting solution was stirred for 1 h at room temperature to prepare the surface for silica coating. Finally, the citrate surface stabilized particles were magnetically recovered, washed thoroughly with deionized water and freeze-dried. Dried beads weighed 1.77 g (MW 231.53, 7.6 mmol); yield=88%. Dynamic light scattering (DLS) and zeta potential measurements were obtained using a Malvern ZETASIZER NANO ZSP. The sample concentrations were adjusted to ˜0.1% w/v particles in deionized water. The samples were sonicated in ultrasonic bath for 1 min and pre-equilibrated for 3 min at 25° C. prior to each measurement. Zeta potential measured was −28.5 mV. Scanning Electron Microscopy (SEM) analysis was obtained from FEI Helios Nanolab 660. SPION stabilization with citrate is a protocol inspired by Khosroshahi et al and Digigow et al. This 1-pot, 2-step procedure leads to citrate surface-stabilized Fe₃O₄ nanoparticles that can be stored in dry form at 4° C.

In this non-limiting example, to prepare the silica glass surface of the above citrate-Fe₃O₄ particles. Re-suspension and sonication of these dry particles in 10% v/v water in ethanol, followed by silica shell formation with hydrolysis of tetraethoxysilane (TEOS) under alkaline condition using 28-30% ammonia, results in silica magnetic particles that can be magnetically separated without further purification (FIG. 2). At the end, the silica coated magnetic microparticles were rinsed with ethanol and dried in vacuum. Dried microparticles weighed 3.4 g. The mass ratio of silica coating was found by the following equation:

Mass ratio_{(silica coating)}=(Mass_{(silica coated particle)}−Mass_{(starting particles))}/Mass_{(silica coated particles)}

The mass ratio of the silica coating to Fe₃O₄ was found to be around 55% averaged over multiple batches using a reactants ratio of TEOS:NP, 4:1 w/w. Zeta potential of this Fe₃O₄@Silica particles measured was −39.6 mV. Dynamic light scattering (DLS) analysis for sizing was recorded as below. FIG. 2 indicated that the Fe₃O₄@Silica particles were 1.77 μm in diameter on average (Peak 1=1.75 μm, 91.1%; Peak 2=99.95 nm, 8.9%).

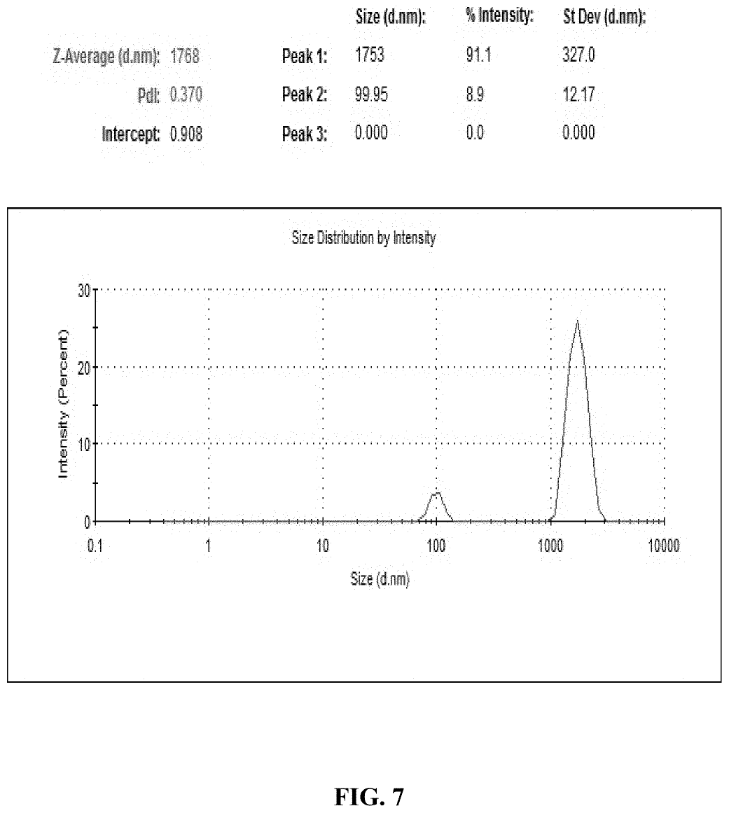

FIG. 7 shows dynamic light scattering (DLS) size measurements of Fe₃O₄@Silica particles with 55% silica mass ratio (TEOS:NP, 4:1 w/w) was obtained using a Malvern ZETASIZER NANO ZSP. Z-average diameter=1.77 um, PDI=0.370, Peak 1=1.75 um (91.1%), Peak 2=0.099 um (8.9%).

Different silica mass ratio were obtained by using different reactants ratio of TEOS:NP, ranging from 2:1, 4:1 to 6:1. Corresponding mass ratios of silica coating ranged from 45%, 55% and 62% were obtained. A mass ratio of TEOS vs starting particles NP of 1:1 was not pursued because of the possibility of incomplete silica enclosure on the Fe₃O₄ magnetic particles. And we observed that a higher silica mass ratio than 55% was not preferred as the additional weight of the silica shell resulted in a slower magnetic response of the coated Fe₃O₄@Silica particles.

Formulation of Fe₃O₄@Silica for RNA Extraction in Zika Assays

Preparation of 10% w/v of the Fe₃O₄@Silica in 1 M Gu·Cl buffer for Zika assays was done by suspension of 100 mg of the Fe₃O₄@Silica prepared above in 500 μl deionized water, then added with 2 M Gu·Cl buffer to make up to 1.0 ml final volume. Zeta potential of this formulated Fe₃O₄@Silica was measured as −4.84 mV.

Alternative Methods for Synthesis of Fe₃O₄@Silica from Polymer Seeds

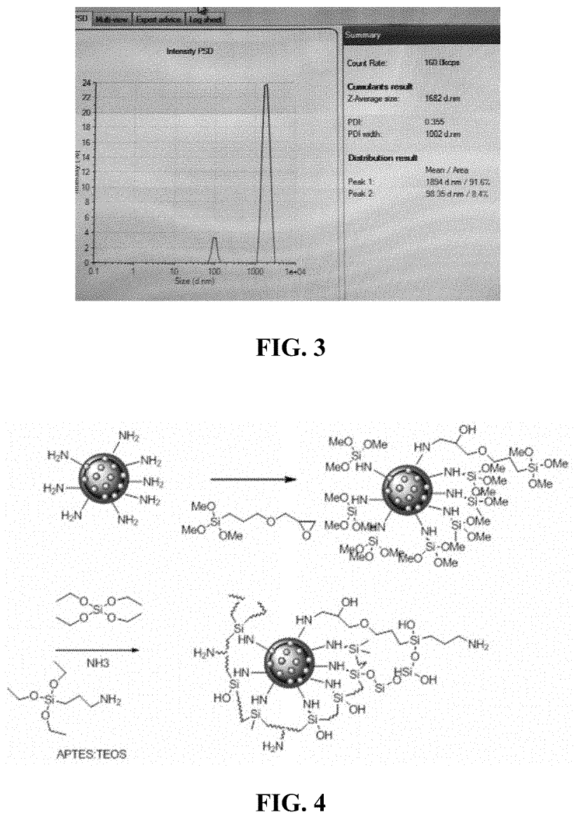

Alternative methods to prepare Fe₃O₄@Silica beads were also tested; for example, polymerizing a mixture of (1) TEOS with γ-aminopropyl-triethoxysilane (APTES); (2) TEOS with (3-mercaptopropyl)trimethoxysilane (MPTMS); and (3) amino surface of magnetic polystyrene particles reacted with (3-glycidyloxypropyl)trimethoxy silane (GLYMO). In typical examples, in-house synthesized amine surface polymer microparticles with approximate 2 μm was used as seeds. 0.5 g of seeds were reacted with 0.2 ml 3-glycidyloxypropyltrimethoxysilane (GTMOS) for 1 h at room temperature in 5 ml ethanol, followed with 0.1 ml tetraethyl orthosilicate (TEOS) or a mixture of 0.1 ml tetraethyl orthosilicate (TEOS) and 0.2 ml (3-Aminopropyl)triethoxysilane (APTES) in 0.2 ml ammonia 28-30% w/w for 4 h at 90° C. (FIG. 3). After reaction, the magnetic particles were magnetically separated and washed with ethanol (5 times) with centrifugation at 3000×g or separated magnetically. Zeta potential measured microparticles with silica surface formed from (TEOS:APTES, 2;1, v/v)=+39.2 mV. microparticles with silica surface formed from TEOS only=+15.3 mV. This preliminary study on the ratio of TEOS:APTES relationship with surface Zeta potential demonstrates the fine tunable controls on the surface charges by the design of combination of silylating reagents used.

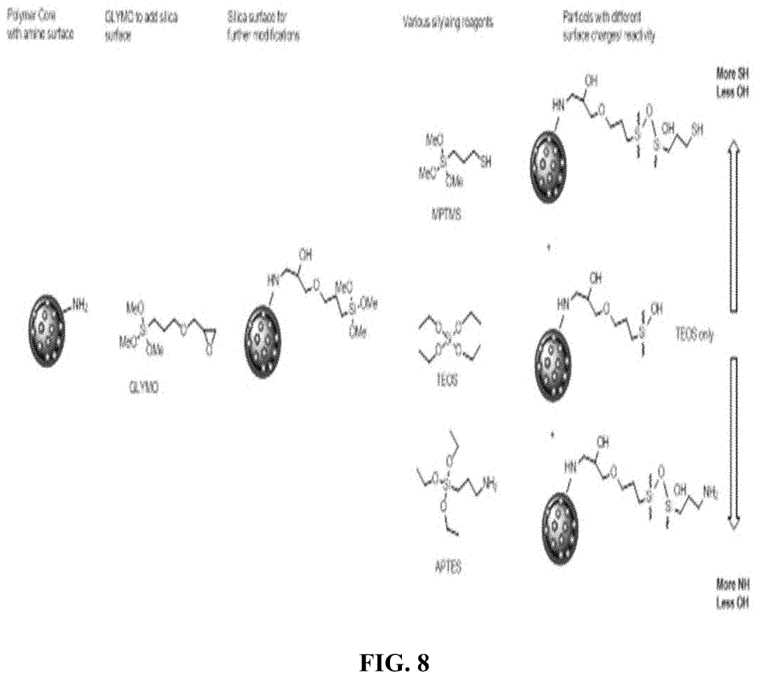

FIG. 8 shows the preparation of silica surface spherical monodispersed microparticles (polymer based), and the additions of variable MPTMS, TEOS, APTES for modified silica surface with different surface charges and reactivity.

ZNAA Assay & Samples Preparation with Fe₃O₄@Silica

ZNAA Assay Workflow:

In one non-limiting example, all necessary assay reagents and consumables were assembled in disposable, barcoded assay cartridges. It should be understood that in some alternative embodiments, the cartridge may contain many but not necessarily all reagents or diluents for the assay(s). Sample collection unit (SCUs) containing serum or capillary whole blood were inserted into assay cartridges (see next section) and the cartridges were inserted into the miniLab. The sample-to-result fully-automated miniLab extracted RNA from samples and performed nucleic acid amplification and detection. Reagents and consumables used for the assay were returned into the cartridge upon assay completion; the assay cartridge was then ejected and disposed of as bio-hazardous waste.

Blood Sample Preparation for the ZNAA Assay:

Each SCU, comprised of two identical storage vessels, contained a total of 160 μl serum or capillary whole blood. As necessary, live ZIKV (strain PRVABC59, Centers for Disease Control, Atlanta, Ga.) was added into serum or capillary whole blood samples. ZIKV was added manually for serum samples or automatically within the miniLab for capillary whole blood samples. The miniLab also added MS2 bacteriophage to serum and capillary whole blood samples as a positive control for sample preparation/RNA extraction and thermal cycling-based amplification and detection.

Automated RNA Extraction from Blood Samples:

Both serum and capillary whole blood samples were first centrifuged and then serum and plasma, respectively, were subjected to lysis, RNA capture onto Fe₃O₄@Silica beads (described in this article), washing, and then RNA elution into water.

Automated Preliminary Amplification:

The liquid handling robot (LHR) within the miniLab added 40 μl of extracted RNA to 60 μl of preliminary amplification master mix. Template-negative, DNase/RNase-free water was used in a separate, parallel reaction as a negative control. Reaction vessels were overlaid with mineral oil (Sigma, St. Louis, Mo.) and transferred by the LHR to a thermal-cycling module in the miniLab to commence RT-PCR.

Automated Isothermal Amplification and Detection:

Primer pairs contained pair-wise complementary 5′ ends that resulted in amplicons containing 5′ overhangs. These overhangs facilitated the generation of concatemers, which are detectable with intercalating fluorescence dye. The Primer design is shown in supplemental methods. Three microliters of pre-amplified product (see above) for both sample and negative control were added by the miniLab into separate wells containing 22 μl of isothermal reaction mix to detect ZIKV or MS2. The ZIKV DNA target amplicon, at 1×10⁶ copies/ml, was used as a positive control for isothermal detection in a separate well. Assays were invalid if any controls failed.

### Further Discussion

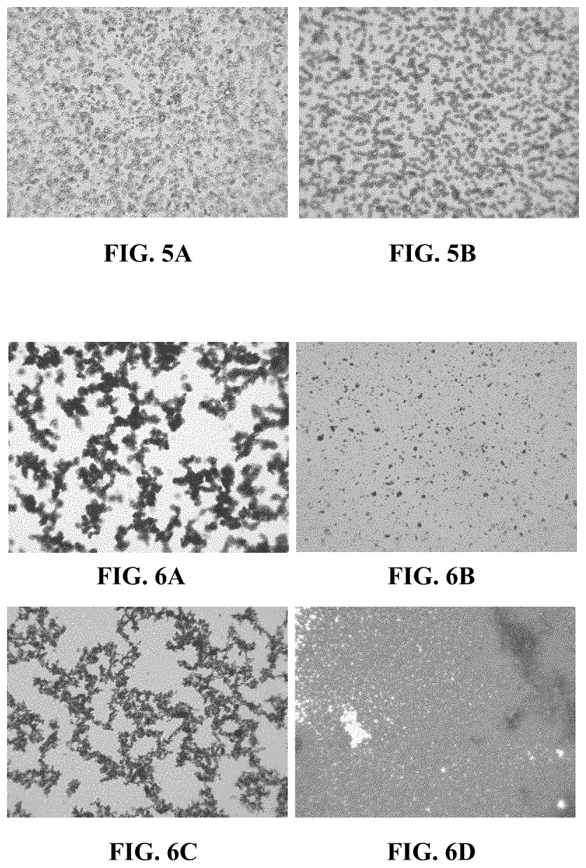

Although Fe₃O₄@Silica derived from polymer seeds pathway (FIGS. 2 and 8) with well-defined spherical shape and monodispersed size as shown in FIG. 5A-6D for the 800× magnification optical image comparison of Dynabeads M280, they require a longer synthetic pathway compared to silica surface beads prepared in FIG. 1. In addition, results generated from a comparison of beads in a nucleic acid assay indicated that magnetic particles with silica surfaces formed with TEOS provided comparable performance to commercially available Zymo product used for RNA separation from biological samples. Aggregated nanoparticles with citrate surfaces, FIG. 5A), were observed under 800× optical microscope. After completing the coating step, the micro-particles FIG. 5b) were less aggregated. To prepare these micro-particles for RNA or DNA binding, Particles showed in FIG. 5b) were formulated in 1M guanidinium chloride solution as a 10% w/v suspension mixture. FIG. 5c) shows an image of commercial Zymo magnetic particles at the same magnification. This preparation method was further optimized to avoid aggregation if it is deemed to decrease the performance. FIG. 5d) shows the well-defined silica-coated magnetic particles of 2 μm diameter, generated by alternative seed coating method described in Section 2.4. FIGS. 6a) and (6b) show the Scanning Electron Microscopy (SEM) analysis of the silica surface iron (II, III) oxide (Fe₃O₄@Silica) particles described in the current work performed as RNA/DNA adsorption medium for sample preparations in PCR-based Theranos Zika assays. Surface morphology shows the nanoparticles fused together by Silica coating to yield the micron size particles. FIG. 6a) confirms the optical image from FIG. 5b), the particles generated with method described in Section 2.2 leads to non-spherical particles which is different from FIG. (5d) particles synthesized by Silica coating from polymer seeds (Section 2.4).

FIGS. 5A and 5B show 800× magnification of microscopic images to illustrate the well-defined spherical shape and monodispersed size: in-house silica coated polymer microparticles (left); reference 2.8-2.6 μm Dynabeads® (right).

FIGS. 6A-6D show (a) 800× optical microscope image of citrated Fe₃O₄. (b) Same magnification of TEOS functionalized silica surface beads used in this assay. (c) Commercial Zymo product. (d) Silica surface beads prepared by another method based on seed polymerization described in Section 2.4. Aggregation is observed in samples (a) and (c).

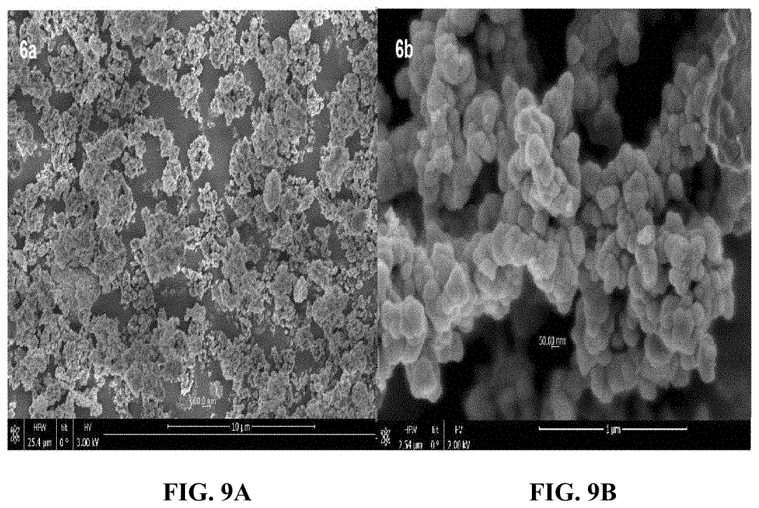

FIGS. 9A-9B show (a) SEM analysis of Fe₃O₄@Silica with 500 nm & 10 μm scales. (b) SEM analysis of Fe₃O₄@Silica with 50 nm & 1 μm scales.

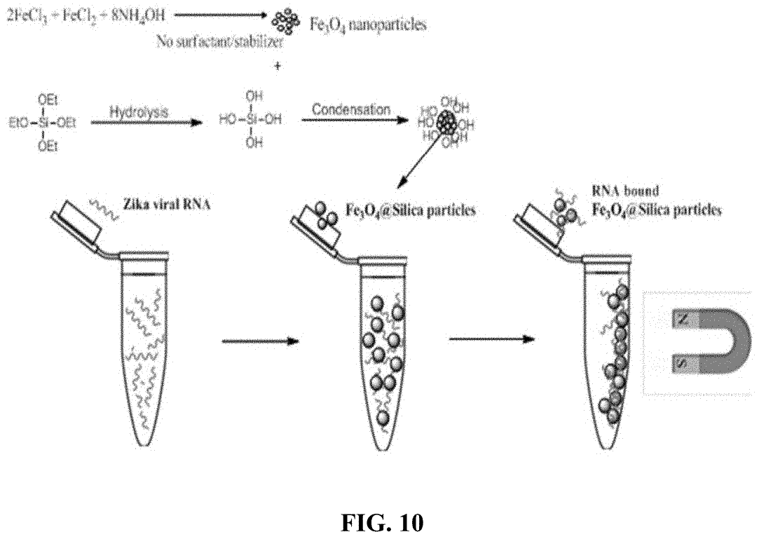

In one non-limiting example, the preparation described in FIG. 2 does not require polymerization of core and multiple coatings for surface functionality. The simplicity and robustness of the method described here makes it very valuable for large-scale, low cost use in DNA and RNA separations, while providing comparable performance to commercially-available Zymo MagBinding® product. The micro-particles prepared by the current method are smaller in size and exhibit less aggregation relative to the commercial products. These two properties provide useful features: (1) smaller size provides same weight of particles containing higher surface area for RNA or DNA loading during sample preparation step; (2) less aggregation, on the other hand results in availability of higher loading areas for binding; (3) a well-defined spherical shape may not be an essential property for the particles made here when they are used as the sorbent material. Experimental results carried out in this work indicate functional performance is not compromised by the shape of the silica particles described here when compared to commercial magnetic micro-particles employed in the same applications. Zeta potential measurements show that the silica-coated particles have a −39.6 mV charge. The silica surface is negatively charged because of the deprotonation of silanol groups (SiO⁻). Once the micro-particles were formulated with 1M guanidinium chloride, Zeta potential of the Fe₃O₄@Silica particles increased to −4.84 mV when measured in DI water. To demonstrate the functional performance of these silica surface magnetic particles in RNA extraction, Zika viral RNA extraction from plasma, followed by PCR-based studies, were conducted. The workflow of our straightforward Fe₃O₄@Silica particles preparation and using these to extract Zika viral RNA from available biological samples is described in FIG. 10. FIG. 10 shows one non-limiting example of the preparation of Fe₃O₄@Silica particles in 1-pot 2-step pathway and workflow of Zika viral RNA extraction with magnetic separation.

Two sets of experiments were performed to establish the utility of the functionalized magnetic micro-particles in the automated detection of Zika virus RNA. The rapid detection of Zika virus has received increased international attention due to the 2015 outbreak in South America and its association with congenital microcephaly. The critical initial step in Zika virus RNA detection assays requires RNA extraction by either manual or automated methods. The first set of experiments demonstrating the use of the magnetic micro-particles described in the current work for RNA extraction employed synthetic Zika RNA spiked into whole blood. These RNA samples were extracted and detected using Theranos miniLab equipment and a qualitative Zika virus nucleic acid amplification test. The second experiments used live Zika virus spiked into whole blood and detected using the same system. In addition, MS2 bacteriophage were spiked into the starting blood samples to serve as positive controls for sample preparation/RNA extraction and thermal cycling-based amplification and isothermal detection. The Theranos miniLab and Zika virus nucleic acid amplification test will be described in detail elsewhere (manuscripts in preparation).

Briefly for this non-limiting example, the Zika virus nucleic acid amplification tests were performed using single-use cartridges containing all necessary assay reagents and consumables that were processed on Theranos' automated, diagnostic platform (“miniLab”) capable of sample preparation and processing. The miniLab contains an automated, multi-channel liquid handling system, centrifuge, thermal-cycler, isothermal heat block with fluorescence detection capabilities, and network functionality. In the miniLab, blood samples were first centrifuged, the resulting plasma was subjected to lysis, and RNA was captured on magnetic beads (commercial or in-house synthesized). Beads were collected and transferred by a sleeved magnetic rod. Samples were washed in commercial wash buffers, and RNA was subsequently eluted from the beads into DNase/RNase-free water.

Detection of Zika RNA was accomplished in the miniLab by a two-step amplification/detection process. A preliminary reverse-transcription and thermocycling amplification of the RNA target took place. This was followed by a proprietary fluorescence-based nested isothermal amplification and Zika nucleic acid (or MS2) detection step. Relative fluorescence measurements were taken every minute, with inflection times (or threshold cycle, Cₜ) used to report the detection of Zika RNA and MS2 control RNA. Non-templated controls (NTCs) (controls without Zika or MS2 samples) were run and measured within the same assay cartridges; all NTC reactions were negative.

In the synthetic Zika (sZika) RNA experiments, 600 copies/mL of synthetic target were spiked into capillary whole blood samples which were then processed using either commercial microparticles (MagBinding® beads, Zymo Research, Irvine, Calif.) (n=3), or the synthesized silica-coated Fe₃O₄ particles described in this paper (n=6). (See Table 3)

TABLE 3
Summary of the inflection times determined using
the Commercial and prepared beads in this work.

| TABLE 3 | MS2 | sZika | NTC |
|---|---|---|---|
| Zymo Commercial beads | 15.9 (0.5) | 15.2 (1.4) | NA |
| Beads prepared in this work | 15.2 (0.7) | 17.7 (2.6) | NA |

Inflection times in min (standard deviation)

The second set of experiments used live Zika virus spiked into whole blood samples. The virus was added at 250 copies/mL. (See Table 4)

TABLE 4
The results of comparing the Zymo beads (n = 2) and
the beads prepared in this work (n = 10).

| TABLE 4 | MS2 | Zika | NTC |
|---|---|---|---|
| Zymo Commercial beads | 16.6 (1.0) | 13.2 (0.0) | NA |
| Beads prepared in this work | 15.6 (0.78) | 13.5 (1.0) | NA |

Inflection times in min (standard deviation)

These two sets of experiments demonstrated comparable performance between the commercial micro-particles and the synthesized micro-particles prepared in this work in capture and extraction of Zika RNA followed by detection of Zika RNA using the Theranos miniLab and Zika virus RNA detection test.

In at least one embodiment herein, the silica surface iron (II, III) oxide (Fe₃O₄@Silica) particles described in the current work performed as an outstanding alternative RNA/DNA adsorption medium for sample preparations in PCR-based assays. The silica coating of these particles prepared easily from reacting tetraethoxysilane with nano Fe₃O₄ seeds by hydrolysis. Silica contents can be controlled effectively by the ratio of TEOS:NP, and the batch of Fe₃O₄@Silica with silica shell weighed about 55% of the total mass was selected for RNA adsorption studies. The particles dispersed well in aqueous and 1M guanidinium chloride solution in 10% w/v ratio for final formulation and application to our miniLab Zika assay workflow. It was shown that mono-dispersity is not a critical material requirement for yielding performance in RNA extraction. Preparation of magnetic particles presented here features simple with short synthetic pathway. Finally, this method allows economical production at larger scale without compromising performance characteristics. Through this work it is concluded that this simple and cost effective method does not compromise the quality of RNA extraction.

While the invention has been described and illustrated with reference to certain particular embodiments thereof, those skilled in the art will appreciate that various adaptations, changes, modifications, substitutions, deletions, or additions of procedures and protocols may be made without departing from the spirit and scope of the invention. For example, with any of the above embodiments, it should be understood that although whole blood may be the sample used, other types of sample such as saliva, mucus, etc. . . . may also be used.

Additionally, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a size range of about 1 nm to about 200 nm should be interpreted to include not only the explicitly recited limits of about 1 nm and about 200 nm, but also to include individual sizes such as 2 nm, 3 nm, 4 nm, and sub-ranges such as 10 nm to 50 nm, 20 nm to 100 nm, etc. . . . .

The publications discussed or cited herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. All publications mentioned herein are incorporated herein by reference to disclose and describe the structures and/or methods in connection with which the publications are cited. For example: U.S. Provisional Application Ser. No. 62/513,999 filed Jun. 1, 2017 and U.S. Provisional Application Ser. No. 62/642,774 filed Mar. 14, 2018 are both fully incorporated herein by reference for all purposes.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. Any feature, whether preferred or not, may be combined with any other feature, whether preferred or not. The appended claims are not to be interpreted as including means-plus-function limitations, unless such a limitation is explicitly recited in a given claim using the phrase “means for.” It should be understood that as used in the description herein and throughout the claims that follow, the meaning of “a,” “an,” and “the” includes plural reference unless the context clearly dictates otherwise. For example, a reference to “an assay” may refer to a single assay or multiple assays. Also, as used in the description herein and throughout the claims that follow, the meaning of “in” includes “in” and “on” unless the context clearly dictates otherwise. Finally, as used in the description herein and throughout the claims that follow, the meaning of “or” includes both the conjunctive and disjunctive unless the context expressly dictates otherwise. Thus, the term “or” includes “and/or” unless the context expressly dictates otherwise.

1. A composition comprising superparamagnetic particles.

2. The composition of claim 1, wherein said particles comprise microbeads.

3. The composition of claim 1, wherein said particles comprise nanobeads.

4. The composition of claim 1, wherein said particles comprise sphere-like magnetic aggregate with a size range of about 1 to about 2 microns.

5. A method of forming microparticles.

6. The method of claim 4, using citrate precipitation.

7. A kit comprising one or more of the particles of claim 1.

8. A kit comprising one or more of the particles of claim 2.

9. A kit comprising one or more of the particles of claim 3.

10-15. (canceled)

16. The method of claim 5 wherein said microparticles are sphere-like particles each with a size range of about 1 to about 2 microns.

17. The method of claim 5 wherein said microparticles each comprise a metal core coated with a polymer.

18. The method of claim 5 wherein said microparticles each comprise a metal core coated with a silica.

19. The method of claim 5 comprising using a one-pot two-step process, wherein a first step comprises using ammonia neutralization of metal particles and a second step comprises using a citrate salt to stabilize the metal particles.

20. The method of claim 19 further comprises silica coating said microparticles by hydrolysis of tetraethoxysilane (TEOS) under alkaline condition.
